(19) United States
(12) Patent Application Publication
(10) Pub. No.: US 2026/0149279 A1
(43) Pub. Date: May 28, 2026

(54) SUPPLY UNIT FOR A DC LOAD, METHOD FOR OPERATING SAME, AND ELECTROLYSIS SYSTEM

(71) Applicant: SMA Solar Technology AG, Niestetal (DE)

(72) Inventor: Andreas Falk, Kassel (DE)

(21) Appl. No.: 19/451,320

(22) Filed: Jan. 16, 2026

Related U.S. Application Data
(63) Continuation of application No. PCT/EP2024/070765, filed on Jul. 22, 2024.

(30) Foreign Application Priority Data
Aug. 18, 2023 (DE) 10 2023 122 158.2

(51) Int. Cl. H02J 3/10; H02J 7/00; H02J 101/10; H02J 101/35

(52) U.S. Cl. CPC H02J 3/10; H02J 7/855; H02J 2101/10; H02J 2101/35; H02J 2207/20

(57) ABSTRACT

The disclosure relates to a supply unit for a DC load, and includes a DC terminal for connecting to the DC load, a first AC terminal connected to a DC bus via a first AC/DC converter, a second AC terminal for connecting to a second AC voltage and which is connected to the DC terminal via a second AC/DC converter, an energy storage unit connected to the DC bus via a first DC/DC converter, a second DC/DC converter which connects the DC bus to the DC terminal and which can be operated in a current-controlling mode with respect to the DC terminal, and a control unit for controlling the supply unit.

### REFERENCE TO RELATED APPLICATIONS

This application is a Continuation of International Application number PCT/EP2024/070765, filed on Jul. 22, 2024, which claims the benefit of German Application number 10 2023 122 158.2, filed on Aug. 18, 2023. The contents of the above-referenced Patent Applications are hereby incorporated by reference in their entirety.

### FIELD

The disclosure relates to a supply unit for a DC load, for example, an electrolyzer. The disclosure also relates to methods for operating and starting up such a supply unit and an electrolysis system comprising one or more supply units.

### BACKGROUND

To produce hydrogen from water by means of an electrolysis reaction, electrolysis systems are known in which an electrolyzer is supplied with electrical power via a supply unit from an AC network. Since such electrolyzers are usually operated as direct current (DC) loads during the electrolysis reaction, the supply unit has one or more rectifying power converters. Depending on their size and design, electrolyzers can have nominal power outputs of up to several tens of megawatts. The supply unit allows for targeted adjustment of the hydrogen production rate, i.e., the amount of hydrogen produced per unit of time. For this purpose, the power converter can be operated in a current-controlling mode at its DC terminal to the electrolyzer. Depending on the design of the electrolyzer, an electrical DC voltage corresponding to the applied current is established at the DC terminal of the electrolyzer, and thus also at the DC terminal of the supply unit. The DC voltage typically increases with increasing hydrogen production rate and can reach values in the range of a few hundred volts to 1500 volts.

To meet the increasing demand for green hydrogen—that is, hydrogen produced exclusively from renewable energy sources via electrolysis—large electrolysis systems with a large number of electrolyzers and a large number of supply units are being designed. Such electrolysis systems have total outputs in the range of several hundred megawatts. Photovoltaics and wind power are used as renewable energy sources. Within the electrolysis systems, the energy loads and energy producers are coupled via an internal AC network. Depending on the availability and/or distance of an upstream power supply network (PSN), the internal AC network may either have no electrical connection at all with the upstream PSN, i.e., be designed as a pure isolated AC power network, or it may have an electrical connection designed for only a small exchange of power between the internal AC network and the upstream PSN. This is the case, for example, with electrolysis systems that are operated in offshore areas. In particular, it is usually required there that the internal AC network has a black start capability, or at least a brown start capability. It must therefore be able to start up without an energy supply or with only a limited energy supply from the upstream PSN. Therefore, special requirements are placed on the supply units used in such an isolated AC power network. Specifically, they should
allow a high-efficiency electrical supply to their assigned electrolyzer,
enable pre-charging of the electrolyzer assigned to them, and
ensure the internal AC network can be started up with no or only minimal external power supply—possibly in conjunction with other supply units assigned to the internal AC network.

The specialist article: Meng, X. [et al.]; “A Novel Multi-Scale Frequency Regulation Method of Hybrid Rectifier and Its Specific Application in Electrolytic Hydrogen Production”; IEEE Transactions on Power Electronics, Vol. 38, 2023, No. 1, pp. 123-129 IEEE Xplore [online]. DOI: 10.1109/TPEL.2022.3207601, In: IEEE; discloses a hybrid rectifier with a thyristor-based and a transistor-based rectifier. The transistor-based rectifier of the hybrid rectifier serves to provide frequency support for an AC network connected to the hybrid rectifier on a short-term/low-power scale, e.g., to smooth a frequency change rate and to gain time for the effect of the thyristor-based rectifier. The thyristor-based rectifier serves to provide frequency support for the AC network on a long-term/high-power scale.

Publication DE 10 2020 124964 A1 also discloses a hybrid rectifier with a thyristor rectifier and a transistor rectifier for supplying a DC load from an AC network. If the DC voltage at a DC output of the hybrid rectifier falls below a voltage threshold, the hybrid rectifier operates in a first operating state in which total active power is supplied from the AC input to the DC output of the hybrid rectifier via the thyristor rectifier and not via the transistor rectifier. When the DC voltage at the DC output of the hybrid rectifier reaches or exceeds the voltage threshold, the total active power from the AC input to the DC output of the hybrid rectifier is supplied via both the thyristor rectifier and the transistor rectifier.

The publication DE 10 2018 133 641 A1 discloses a method for operating an electrolysis device with a converter which is connected to an AC network on the AC side via a decoupling impedance and an electrolyzer which is connected to the converter on the DC side. At a network frequency that corresponds to a nominal frequency of the AC network and is constant over time, the electrolysis device is operated with an electrical power that is between 50% and 100% of the nominal power of the electrolyzer. The converter is operated in a voltage-impacting manner, so that the AC active power drawn from the AC network is changed directly depending on a change and/or a rate of change of the network frequency in the AC network.

### SUMMARY

The disclosure is directed to a supply unit for a DC load, for example, an electrolyzer, which enables the above-mentioned requirements to be met in an improved manner. Furthermore, the disclosure aims to demonstrate a method for operating the supply unit and an electrolysis system with such a supply unit.

A supply unit according to the disclosure comprises
a DC terminal for connecting to the DC load,
a first AC terminal which is connected to a DC bus via a first AC/DC converter,
a second AC terminal which is connected to the DC terminal via a second AC/DC converter,
an energy storage unit that is connected to the DC bus via a first DC/DC converter,
a second DC/DC converter which connects the DC bus to the DC terminal and can be operated in a current-controlling mode with respect to the DC terminal, and
a control unit for controlling the supply unit, in particular the first and second AC/DC converters, the first and second DC/DC converters and the respective associated isolation units. In addition:
the first DC/DC converter is designed as a bidirectional DC/DC converter and the control unit is configured to operate the first DC/DC converter in a voltage-controlling mode with respect to the DC bus, and
the first AC/DC converter is designed as a bidirectional AC/DC converter and the control unit is set up to operate the first AC/DC converter in a voltage-controlling mode with respect to the first AC terminal.

The term DC load refers to a device that consumes direct current (DC) power during its operation, for example, that is supplied by DC power. However, this does not mean that it is designed exclusively for consuming DC power. Rather, it is also possible for the device to operate both as a DC load and as a DC source, consuming DC power in some time periods and generating DC power in other time periods. The DC load could be, for example, an electrolyzer. However, the application is not limited to one electrolyzer as a DC load. For example, certain electrolyzers can operate both as DC loads and as DC sources, especially as fuel cells. The first DC terminal can be designed for connection to a first secondary winding of a transformer unit, which supplies a first AC voltage U₁ to the first AC terminal of the supply unit provided from an AC network. The second AC terminal can be designed to connect to a second secondary winding of the transformer unit in order to supply a second AC voltage U₂ to the second AC terminal of the supply unit from the AC network. The first AC/DC converter, and the second AC/DC converter, can each be a transistor-based AC/DC converter for example. The second AC/DC converter can also be designed as a bidirectional AC/DC converter, as is the case for the first AC/DC converter. The first DC/DC converter, as well as the second DC/DC converter, can each be implemented as a transistor-based DC/DC converter.

A method according to the disclosure for operating the supply unit aims in a first aspect at the electrical supply of the DC load, for example, an electrolyzer. In this process, the supply unit is connected to the DC load, for example, the electrolyzer as the DC load, via its DC terminal. A first AC voltage U₁ is applied to the first AC terminal of the supply unit, for example, by connecting the first AC terminal to a first secondary winding of a transformer unit. Furthermore, a second AC voltage U₂ is supplied to the second AC terminal of the supply unit, for example, by connecting the second AC terminal to a second secondary winding of the transformer unit. The method comprises:
supplying the DC load, for example, the electrolyzer, in partial load operation or during its pre-charging with a power flow through the first AC/DC converter, which is operated in a voltage-controlling mode with respect to the first AC terminal, while a power flow through the second AC/DC converter is suppressed, and
supplying the DC load, especially the electrolyzer, in normal operation with a simultaneous power flow through the first AC/DC converter and the second AC/DC converter. The control unit or circuit of the supply unit is set up to operate the supply unit in a state connected to the AC network and the DC load according to the operating method. The control unit or circuit can also be configured to operate the supply unit—possibly in a state connected to the AC network and the DC load—according to the start-up method.

A method according to the disclosure for starting up such a supply unit aims in a second aspect at a black start or brown start of the supply unit and also of an AC network comprising the supply unit. In this method, the supply unit is connected to the DC load, for example, an electrolyzer, via its DC terminal. Furthermore, the supply unit is connected to a first secondary winding via its first AC terminal and to a second secondary winding of a transformer unit via its second AC terminal. The black start or brown start method includes:
charging the energy storage unit of the supply unit, if it is not already sufficiently charged,
providing a DC bus voltage U_{DC bus} on the DC bus through voltage-controlling operation of the first DC/DC converter,
providing a first AC voltage U₁ at the first AC terminal of the supply unit by a voltage-controlling operation of the AC/DC converter with respect to the first AC terminal,
closing an AC isolation unit associated with the supply unit and/or the first AC/DC converter, if it is not already closed. The control unit of the supply unit is set up to operate the supply unit—if necessary in a state connected to the AC network and the DC load—according to the start-up method. The control unit can additionally be configured to operate the supply unit in a state connected to the AC network and the DC load according to the operating method.

With a supply unit designed in this way and with these methods, the aforementioned object can be achieved in a particularly efficient manner. Thus, the supply unit allows for an electrical supply of its respective assigned DC load, which can be designed, for example, as an electrolyzer, with high efficiency. Specifically, in partial load operation, the DC load is only supplied via a power flow from the first AC/DC converter, while a power flow from the second AC/DC converter is suppressed. This allows the first AC/DC converter to be operated particularly efficiently and with high efficiency in the partial load range due to the lower operating voltage. Only during normal operation of the DC load is its electrical supply provided via simultaneous power flows through the first and second AC/DC converters. Since both AC/DC converters are connected to different AC voltages U₁, U₂ via their respective assigned AC terminals, for example, via different, especially galvanically isolated, secondary windings of a transformer unit, the first AC/DC converter and the second AC/DC converter are decoupled from each other in such a way that a voltage-controlling operation of the first AC/DC converter and—simultaneously—a current-controlling operation of the second AC/DC converter is enabled. Furthermore, the overall losses incurred during the conversion can be reduced. Both AC/DC converters can be operated in such a way as to achieve their respective assigned DC voltages from their respective assigned AC voltages, thus avoiding excessive boosting and associated conversion losses for each of the two AC/DC converters.

In one embodiment, pre-charging the DC load associated with the supply unit, especially the electrolyzer, can also be carried out particularly efficiently. Because the first DC/DC converter is bidirectional and can be operated in a voltage-controlling mode with respect to the DC bus, it can adjust the DC bus voltage U_{DC,Bus} applied to the DC bus, especially in the event of voltage fluctuations in the internal AC network and/or voltage changes due to the energy content of the energy storage unit, to maintain a constant value. The second DC/DC converter can use this constant DC voltage and is then operated in a current-controlling mode with respect to the DC terminal, i.e., it is operated in such a way as to provide a predefined current at its output—and thus at the DC terminal of the supply unit. In this way, the second DC/DC converter operates as a current source during pre-charging, enabling controlled pre-charging without uncontrolled current fluctuations. This also applies to partial load operation and/or normal operation of the supply unit, since the second DC/DC converter can also be operated in a current-controlling mode with respect to the DC terminal.

Because the supply unit itself has a suitably dimensioned energy storage system, it is also possible to start up the internal AC network with no or only a small external power supply—possibly in conjunction with other supply units assigned to the internal AC network. If the energy storage unit is not sufficiently charged, it can be recharged via an auxiliary energy source, such as a generator with an internal combustion engine or a fuel cell. The auxiliary energy source can be connected to the internal AC network for this purpose. It can have only a small nominal power output, since charging the energy storage does not have to be 100% and also does not have to be done within a short time. Regardless, in a large number of appropriately designed supply units connected to the internal AC network, there are usually individual supply units that have a sufficiently charged energy storage unit, which can then be used as a supply unit(s) for black start or brown start. In a black or brown start, the first DC/DC converter can provide a predefined DC voltage on the DC bus by drawing power from the energy storage unit. Due to its voltage-providing operation with respect to the DC bus, the first DC/DC converter can keep this DC voltage constant on the DC bus—especially in the event of a drop in DC voltage at the energy storage unit caused by energy withdrawal. From the constant DC bus voltage U_{DC,Bus}, the first AC/DC converter can draw power from the DC bus and, due to its bidirectional operation, generate a first AC voltage U₁ at the first AC terminal—and also via the first secondary winding on the primary side of the transformer unit. This is possible therefore because the first AC/DC converter can be operated in a voltage-controlling mode with respect to the first AC terminal, thus ensuring suitable premagnetization of the transformer unit. Advantageously, the first AC voltage U₁ can be at least temporarily kept constant in one embodiment. Afterwards, an AC isolation unit located on the primary side of the transformer unit can be closed, unless it is already closed, so that the AC voltage is present in the internal AC network, or at least in a sub-area of the internal AC network. The AC voltage present in the internal AC network can be used to synchronize and connect other supply units assigned to the internal AC network, after they have generated an AC voltage U₁ to their first AC terminal in the same manner. Energy generation units assigned to the internal AC network, such as photovoltaic (PV) systems and/or wind power systems, can also synchronize and connect to the AC voltage present in the internal AC network, which is maintained by the supply units already connected to it.

Advantageous embodiments of the disclosure are specified in the following description and the dependent claims, the features of which can be applied individually and in any desired combination with one another.

In one version of the supply unit, the second AC/DC converter can be operated in a current-controlling mode with respect to the DC terminal. Accordingly, the control unit or circuit can also be configured to operate the second AC/DC converter in a current-controlling mode with respect to the DC terminal, so that a predetermined current is provided at its DC terminal. This is advantageous if a power flow is also provided by the second AC/DC converter, for example, in the normal operation of the supply unit. In particular, when an electrolyzer is used as a DC load, a production rate can also be specified for the electrolysis process via the second AC/DC converter, just as is the case with the second DC/DC converter with its current-controlling mode with respect to the DC terminal. Alternatively or cumulatively, it is possible that the second DC/DC converter is designed as a bidirectional DC/DC converter with respect to its power flow. In this way, especially in the case of an electrolyzer as a DC load, an electrical charge that may be available in the electrolyzer can be used in addition to the energy storage when starting up the internal AC network. It can be advantageous if the second DC/DC converter can be operated in a voltage-controlling mode with respect to the DC bus when power flows towards the DC bus. In one embodiment, the control unit or circuit can be configured to operate the second DC/DC converter in a voltage-controlling mode with respect to the DC bus. In this way, the second DC/DC converter can optimally support the first DC/DC converter in setting a DC voltage on the DC bus. Additionally, it is also possible to use a bidirectional second DC/DC converter to discharge an input capacitance of the DC load in a controlled manner and to transfer the charge via the DC bus and the first DC/DC converter to the energy storage unit in order to store it there. For this purpose, the energy storage unit can advantageously include one or more supercapacitors and/or one or more accumulators.

In one embodiment, the second DC/DC converter can be configured to reduce a DC voltage U_{DC,Bus} applied to the DC bus, to a DC voltage U_{DC,21} applied to the DC terminal, i.e., to operate in a deep-leveling manner towards the DC terminal. When power flows from the DC terminal towards the DC bus, it can operate in a correspondingly boosting manner. In this way, the second DC/DC converter can, on the one hand, perform a controlled pre-charging of an input capacitance of the DC load starting from a discharged, i.e., voltage-free, input capacitance. On the other hand, this also makes it possible to completely, or at least almost completely, discharge the input capacity of the DC load if necessary.

It is possible in one embodiment that the AC network itself has two different AC voltages, in particular two AC voltages with different voltage amplitudes. In this case, the AC voltage with the smaller voltage amplitude can be connected to the first AC terminal and the AC voltage with the larger voltage amplitude to the second AC terminal. Alternatively, it is also possible that the supply unit additionally includes a transformer unit or is connected to a transformer unit. The transformer unit can have a primary side for connection to an AC network and a secondary side with a first secondary winding and a second secondary winding. The first secondary winding can be configured to provide the first AC voltage U₁ and can be connected to the first AC terminal. The second secondary winding can be configured to provide the second AC voltage U₂ and can be connected to the second AC terminal. The winding ratio of the transformer unit can be designed such that a second amplitude Û₂ of the second AC voltage U₂ is larger, in particular by at least a factor of 1.3, than a first amplitude Û₁ of the first AC voltage U₁. This can be advantageous, for example, if a DC bus voltage exceeds a DC voltage applied to the electrolyzer while the electrolyzer is operating at its maximum possible power, for example its nominal power. Alternatively, the winding ratio of the transformer unit can also be designed such that a second amplitude Û₂ of the second AC voltage U₂ is smaller, in particular by at least a factor of 1.3, than a first amplitude Û₁ of the first AC voltage U₁. This can be advantageous, for example, if a DC bus voltage drops below a DC voltage applied to the electrolyzer while the electrolyzer is operating at its maximum possible power, for example its nominal power. However, within the scope of the disclosure it is also possible that the first amplitude Û₁ of the first AC voltage U₁ is equal to the second amplitude Û₂ of the second AC voltage U₂.

During normal operation, for example, at a nominal power of the DC load, for example, the electrolyzer, the total power flow provided by the supply unit can be distributed as follows: 25% to 40% via the first AC/DC converter and 60% to 75% via the second AC/DC converter.

To suppress the power flow through the second AC/DC converter during partial load operation and/or when pre-charging the DC load, the second AC/DC converter can be connected to the DC terminal of the supply unit via a disconnect switch. Alternatively or cumulatively, an AC disconnect switch can also be arranged between the second AC terminal and the second AC/DC converter. The disconnect switch can be located in a connection module of the supply unit. The supply unit may also include additional isolation units, for example, between the first AC/DC converter and the first AC terminal, between the first DC/DC converter and the energy storage unit and/or between the second DC/DC converter and the DC terminal. Several of the disconnect switches, and possibly several fuses, can be arranged in the connection module of the supply unit.

Various DC loads also require AC loads to be supplied with electricity during their operation. For example, in an electrolyzer, DC loads such as pumps for conveying and removing the media, and possibly also a heater, must be supplied with electricity. Advantageously, the supply unit can also have an additional AC auxiliary supply terminal for supplying one or more AC loads assigned to the DC load.

An electrolysis system according to the disclosure comprises:
one or more electrolyzers as DC loads, and
one or more supply units, and
one or more transformer units that are part of one or more supply units, or via which one or more supply units can be connected to an AC network. The advantages already explained in conjunction with the supply unit and the method arise.

In one embodiment, the electrolysis system can have several supply units, wherein at least one of the one or more transformer units has more than two secondary windings, and wherein a plurality of supply units can be connected to the AC network via a common transformer unit. The electrolysis system may also include an auxiliary energy source for charging the energy storage unit(s). The auxiliary energy source can be designed as a hydrogen-powered auxiliary energy source and may include, for example, an internal combustion engine or a fuel cell.

### BRIEF DESCRIPTION OF THE FIGURES

The disclosure is illustrated below with the aid of figures. In the figures:

FIG. 1 is a first embodiment of an electrolysis system according to the disclosure;

FIG. 2 is a second embodiment of an electrolysis system according to the disclosure.

### DETAILED DESCRIPTION

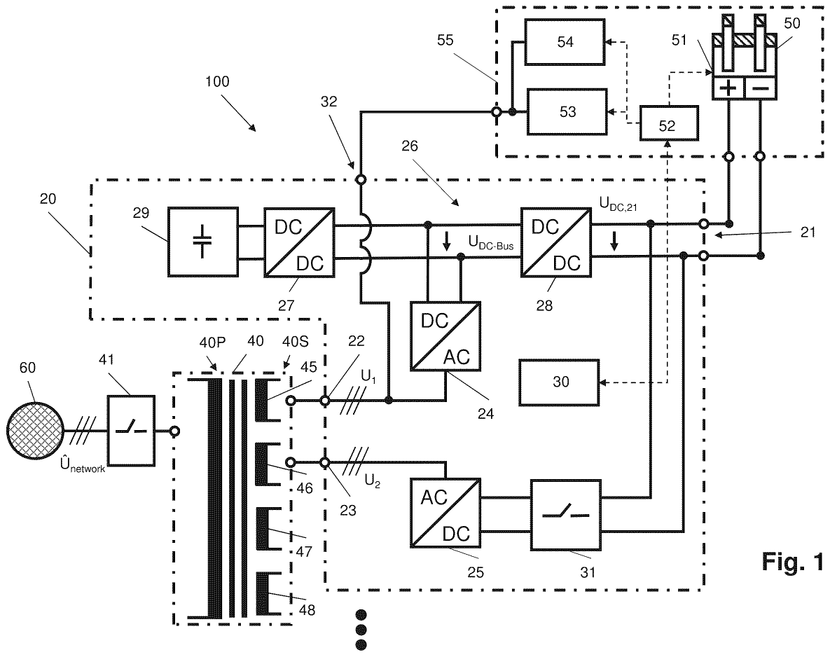

FIG. 1 is a first embodiment of an electrolysis system 100 according to the disclosure with several supply units 20, each of which is connected to a DC load 50—here by way of example an electrolyzer 51. The electrolyzer 51 is part of an electrolysis unit 55, which includes one or more pumps 53 for conveying electrolysis reactants and for removing electrolysis products, a heater 54 for temperature control of the electrolysis reactants and, if applicable, the electrolyzer 50, as well as a control unit 52 for controlling the electrolysis unit 55. The multiple supply units 20 can each be of the same type, or at least largely of the same type, which is why only one of the multiple supply units 20 is shown in FIG. 1. Further supply units 20 are symbolized by the three dots in FIG. 1.

The supply unit 20 has a first AC terminal 22, which is connected to a DC bus 26 via a first bidirectionally operable AC/DC converter 24. A second AC terminal 23 of the supply unit 20 is connected to a DC terminal 21 of the supply unit 20 via a second AC/DC converter 25 and a disconnect switch 31. Furthermore, the first AC terminal 22 is connected to an AC auxiliary supply terminal 32, via which AC loads assigned to the DC load—here, for example, the pump 53 and the heater 54—can be supplied.

The DC bus 26 is connected to an energy storage unit 29 via a bidirectionally operable first DC/DC converter 27. The first DC/DC converter 27, depending on the voltage ratio of the energy storage unit 29 and a voltage U_{DC bus} applied to the DC bus 26, can be a DC/DC converter that increases towards the DC bus 26, or a DC/DC converter that decreases towards the DC bus 26. Within the scope of the disclosure, a combined boost/buck converter can also be used as the first DC/DC converter 27. The first DC/DC converter 27 can be operated in a voltage-controlling mode with respect to the DC bus 26, i.e., it is capable of setting a predefined voltage U_{DC bus} on the DC bus 26 and keeping it constant. For this purpose, it can transfer electrical power from the energy storage unit 29 to the DC bus 26 or back. The DC bus 26 is also connected to the DC terminal 21 of the supply unit 20 via a second DC/DC converter 28. The second DC/DC converter 28 is designed in the form of a DC/DC converter decreasing from the DC bus 26 towards the DC terminal 21 and can be operated in a current-controlling mode with respect to the DC terminal 21. It is therefore able to set and maintain a predefined current at its connection to the DC terminal 21. Optionally, the second DC/DC converter 28 can also be designed to operate bidirectionally, so that electrical power can be transferred not only from the DC bus 26 towards the DC terminal 21, but also from the DC terminal 21 towards the DC bus 26. The supply unit 20 also has a control unit 30 for its control. For control purposes of the electrolysis system 100, this is connected to the control unit 52 of the electrolysis unit 55, which is symbolized by a dashed line in FIG. 1.

For the energy supply of the DC load 50, the supply unit 20 is connected via a transformer unit 40 and an AC isolating unit or circuit/switch 41 to an AC network 60, which has an AC voltage U_{network} with the amplitude Û_{network}. The transformer unit 40 has a primary side 40P coupled to the AC network 60 and a secondary side 40S that can be coupled to several supply units 20 and includes several secondary windings—for example, four secondary windings. Of the four secondary windings 45-48, the AC voltage U₁ is applied to the first secondary winding 45 with the amplitude Û₁, while the second AC voltage U₂ is applied to the second secondary winding 46 with the amplitude Û₂. The first secondary winding 45 is connected to the first AC terminal 22 of the supply unit 20, the second secondary winding 46 to the second AC terminal 23 of the supply unit 20. Furthermore, the third secondary winding 47 can be connected to a first AC terminal 22 and the fourth secondary winding 48 to a second AC terminal 23 of another supply unit 20 (not shown in FIG. 1). The third secondary winding 47 can provide a first AC voltage U₁ and the fourth secondary winding 48 can exhibit a second AC voltage U₂. The amplitudes of the first AC voltages U₁ at the secondary windings 45 and 47 can be the same, but also different. Similarly, the amplitudes of the second AC voltages U₂ at the secondary windings 46 and 48 may also be the same, but also different. The additional supply unit 20 can be connected to the same electrolyzer 51 of the supply unit 20. Alternatively, the additional supply unit 20 can also have a separate, assigned additional electrolyzer 51 or an additional electrolysis unit 55.

In partial load operation of the electrolyzer 51 and/or during its pre-charging, the disconnect switch 31 is open, so that a power flow through the second AC/DC converter 25 is prevented. In these cases, the power supply is provided via the second DC/DC converter 28, which is operated in a current-controlling mode and draws electrical power from the DC bus 26. The power taken from the DC bus 26 is fed back to it via the first AC/DC converter 24 from the AC network 60, and if necessary also via the first DC/DC converter 27 from the energy storage unit 29. The first DC/DC converter 27 is operated in a voltage-controlling mode to the DC bus 26. Should the DC bus voltage U_{DC bus} increase and exceed a predefined value, the first DC/DC converter 24 can counteract the increase by directing a power flow into the energy storage unit 29. Conversely, should the DC bus voltage U_{DC bus} drop, the first DC/DC converter 24 can counteract the drop by means of a power flow directed from the energy storage 29 into the DC bus 26. In normal operation, the electrolyzer 51 is supplied by a simultaneous power flow from both the first AC/DC converter 24 and the second AC/DC converter 25. For this purpose, a voltage at the output of the second AC/DC converter 25 was previously matched with a voltage applied to the DC terminal 21 and the disconnect switch 31 was closed. Even in normal operation, the first DC/DC converter 27 can be operated in a voltage-controlling mode with respect to the DC bus 26.

In the case of a black and/or brown start, an internal AC network 60 is to be built up on the primary side 40P of the transformer unit 40 and the transformer unit is to be premagnetized. For this purpose, a predefined DC bus voltage U_{DC bus} is built up on the DC bus 26 via the first DC/DC converter 27. The first AC/DC converter 24 is operated in a voltage-controlling mode with respect to the first DC terminal 22 and thus generates an AC voltage at the first secondary winding 45—and therefore also on the primary side 40P of the transformer unit 40. In the event that the supply unit 20 is the one that is to be the first of the several supply units 20 to establish the internal AC network, i.e., if there is no AC voltage yet in the AC network, the AC isolation unit 41 can be closed and the AC voltage in the AC network can develop together with the AC voltage generated on the primary side of the transformer unit 40. In the event that an AC voltage is already present in the AC network, the AC isolating unit 41 can be open and only closed after the AC voltage on the primary side 40P of the transformer unit 40 has synchronized with the AC voltage U_{network} in the AC network 60. Alternatively, it is also possible that the supply unit 20 has a further AC isolation unit (not shown in FIG. 1) arranged between the first AC/DC converter 24 and the first AC terminal 22. For synchronization (with the AC isolation unit 41 closed), an AC voltage applied to the AC-side terminal of the first AC/DC converter 24 can be synchronized with an AC voltage applied to the first secondary winding 45 and thus to the first AC terminal 22 of the supply unit 20. Once synchronization has been achieved, the further AC isolation unit can then be closed.

The generation of the AC voltage in the internal AC network 60 does not necessarily have to be carried out up to a nominal voltage of the AC network 60 solely by the supply unit 20 which was first connected to the internal AC network 60 and using only its associated energy storage 29. Rather, it is possible that the buildup of the nominal AC voltage U_{network} will be done in stages. For example, the first supply unit 20 connected to the internal AC network 60 can only generate a fraction of the nominal voltage of the AC network 60, to which other supply units 20 assigned to the internal AC network 60 then synchronize. After their synchronization, these can also be connected to the internal AC network 60 and, with their respective energy storage units 29, enable a further increase in the AC voltage U_{network} in the AC network 60. Alternatively or cumulatively, other energy generation systems, such as photovoltaic (PV) or wind power systems, can also be synchronized with and connected to the internal AC network 60.

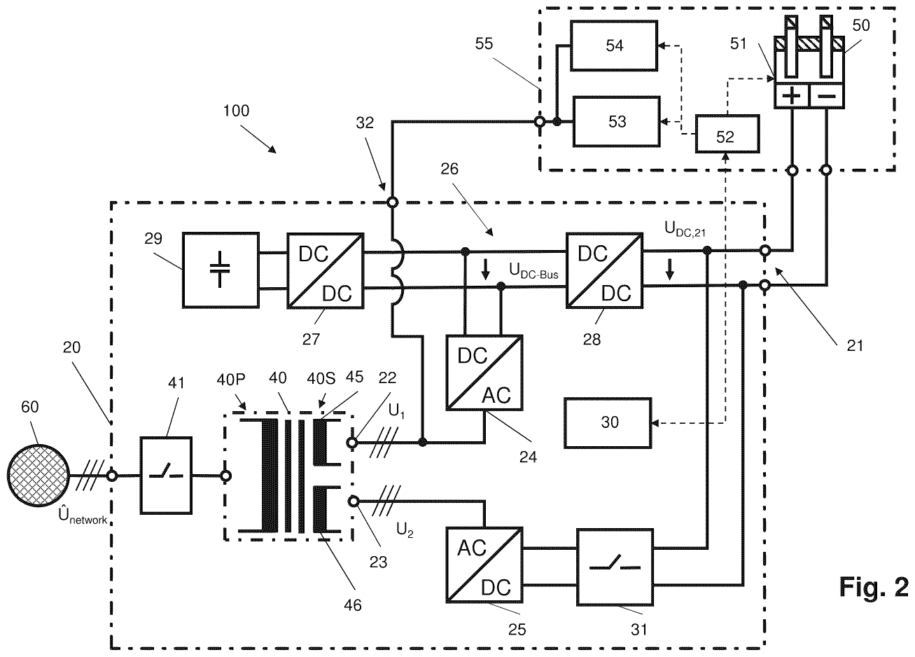

FIG. 2 is a second embodiment of an electrolysis unit 100 according to the disclosure. It is similar in many respects to the first embodiment of the electrolysis unit 100, which is why reference is made to the description of FIG. 1 with regard to the similar features. The following explains only the differences from the embodiment shown in FIG. 1.

The second embodiment of the electrolysis system 100 shown in FIG. 2 has only one supply unit 20, which, however, unlike the supply unit 20 of FIG. 1, itself includes a transformer unit 40 and an AC isolating unit 41. The transformer unit 40 is connected to the AC network 60 via the AC isolating unit 41 with its primary side 40P. In contrast to FIG. 1, the secondary side 40S of the transformer unit 40 has only two secondary windings 45, 46, namely a first secondary winding 45 connected to the first AC terminal 22 and a second secondary winding 46 connected to the second AC terminal 23. Partial load operation, normal operation, as well as pre-charging of the electrolyzer 51 can be carried out analogously to the manner described in FIG. 1. The same applies to starting up an internal AC network 60 during a black or brown start.

In the electrolysis system 100 in FIG. 2, only a supply unit 20 with a correspondingly associated electrolysis unit 55 is shown. Alternatively, it is also possible that the electrolysis system includes further supply units 20, each with an associated electrolysis unit 55, which are coupled to the AC network 60 in parallel with the supply unit 20 shown.

What is claimed is:

1. A supply unit for a DC load, wherein the supply unit comprises:
a DC terminal configured to connect to the DC load;
a first AC terminal connected to a DC bus via a first AC/DC converter;
a second AC terminal connected to the DC terminal via a second AC/DC converter;
an energy storage device connected to the DC bus via a first DC/DC converter;
a second DC/DC converter connected between the DC bus and the DC terminal and configured to be operated in a current-controlling mode with respect to the DC terminal; and
a control circuit configured to control the supply unit;
wherein the first DC/DC converter comprises a bidirectional DC/DC converter, and the control circuit is configured to operate the first DC/DC converter in a voltage-controlling mode with respect to the DC bus, and
wherein the first AC/DC converter comprises a bidirectional AC/DC converter, and the control circuit is configured to operate the first AC/DC converter in a voltage-controlling mode with respect to the first AC terminal.

2. The supply unit according to claim 1, wherein the control circuit is configured to operate the second AC/DC converter in a current-controlling mode with respect to the DC terminal.

3. The supply unit according to claim 1, wherein the second DC/DC converter comprises a bidirectional DC/DC converter.

4. The supply unit according to claim 1, wherein the supply unit additionally comprises a transformer unit or wherein the supply unit is connected to a transformer unit, wherein the transformer unit has a primary side configured to connect to an AC network and a secondary side with a first secondary winding producing a first AC voltage and a second secondary winding producing a second AC voltage, wherein the first secondary winding is connected to the first AC terminal and the second secondary winding is connected to the second AC terminal.

5. The supply unit according to claim 4, wherein a winding ratio of the transformer unit is configured such that a second amplitude Û₂ of the second AC voltage is larger by at least a factor of 1.3, than a first amplitude Û₁ of the first AC voltage.

6. The supply unit according to claim 4, wherein a winding ratio of the transformer unit is configured such that a second amplitude of the second AC voltage is smaller by at least a factor of 1.3, than a first amplitude of the first AC voltage.

7. The supply unit according to claim 1, wherein the energy storage device comprises a supercapacitor or an accumulator, or both.

8. The supply unit according to claim 1, wherein the second DC/DC converter is configured to reduce a DC voltage applied to the DC bus to a DC voltage applied to the DC terminal.

9. The supply unit according to claim 1, wherein the second AC/DC converter is connected to the DC terminal via a disconnect switch.

10. The supply unit according to claim 1, additionally comprising a further AC auxiliary supply terminal configured to supply one or more AC loads associated with the DC load.

11. A method for operating a supply unit for a DC load, wherein the supply unit comprises:
a DC terminal configured to connect to the DC load;
a first AC terminal connected to a DC bus via a first AC/DC converter;
a second AC terminal connected to the DC terminal via a second AC/DC converter;
an energy storage device connected to the DC bus via a first DC/DC converter;
a second DC/DC converter connected between the DC bus and the DC terminal and configured to be operated in a current-controlling mode with respect to the DC terminal; and
a control circuit configured to control the supply unit;
wherein the first DC/DC converter comprises a bidirectional DC/DC converter, and the control circuit is configured to operate the first DC/DC converter in a voltage-controlling mode with respect to the DC bus,
wherein the first AC/DC converter comprises a bidirectional AC/DC converter, and the control circuit is configured to operate the first AC/DC converter in a voltage-controlling mode with respect to the first AC terminal, and
wherein the supply unit is connected via its DC terminal to an electrolyzer as the DC load, and wherein the supply unit is connected via its first AC terminal to a first AC voltage and via its second AC terminal to a second AC voltage, comprising:
supplying the electrolyzer in partial load operation or during pre-charging of the electrolyzer with a power flow through the first AC/DC converter, which is operated in a voltage-controlling mode with respect to the first AC terminal, while a power flow through the second AC/DC converter is suppressed, and
supplying the electrolyzer in normal operation with a simultaneous power flow through the first AC/DC converter and the second AC/DC converter.

12. The method according to claim 11, wherein a pre-charging of the electrolyzer is carried out using a power flow through the second DC/DC converter operated in a current-controlling mode.

13. The method according to claim 11, wherein a total power flow provided by the supply unit during normal operation of the electrolyzer is distributed as follows: 25%-40% via the first AC/DC converter and 60% to 75% via the second AC/DC converter.

14. A method for starting a supply unit for a DC load that comprises:
a DC terminal configured to connect to the DC load;
a first AC terminal connected to a DC bus via a first AC/DC converter;
a second AC terminal connected to the DC terminal via a second AC/DC converter;
an energy storage device connected to the DC bus via a first DC/DC converter;
a second DC/DC converter connected between the DC bus and the DC terminal and configured to be operated in a current-controlling mode with respect to the DC terminal; and
a control circuit configured to control the supply unit;
wherein the first DC/DC converter comprises a bidirectional DC/DC converter, and the control circuit is configured to operate the first DC/DC converter in a voltage-controlling mode with respect to the DC bus,
wherein the first AC/DC converter comprises a bidirectional AC/DC converter, and the control circuit is configured to operate the first AC/DC converter in a voltage-controlling mode with respect to the first AC terminal, and
wherein the supply unit is connected via its DC terminal to an electrolyzer as the DC load, and wherein the supply unit is connected via its first AC terminal to a first AC voltage and via its second AC terminal to a second AC voltage,
wherein the supply unit is connected via its first AC terminal to a first secondary winding and via its second AC terminal to a second secondary winding of a transformer unit, wherein a black start or brown start method of the supply unit comprises:
providing a DC bus voltage on the DC bus by a voltage-controlling operation of the first DC/DC converter;
providing a first AC voltage at the first AC terminal of the supply unit by a voltage-controlling operation of the first AC/DC converter with respect to the first AC terminal; and
closing an AC isolation unit associated with the supply unit and/or the first AC/DC converter, provided that it is not already closed.

15. An electrolysis system, comprising:
one or more electrolyzers as DC loads,
one or more supply units, wherein each of the one or more supply units comprise:
a DC terminal configured to connect to a DC load of the one or more DC loads;
a first AC terminal connected to a DC bus via a first AC/DC converter;
a second AC terminal connected to the DC terminal via a second AC/DC converter;
an energy storage device connected to the DC bus via a first DC/DC converter;
a second DC/DC converter connected between the DC bus and the DC terminal and configured to be operated in a current-controlling mode with respect to the DC terminal; and
a control circuit configured to control the supply unit;
wherein the first DC/DC converter comprises a bidirectional DC/DC converter, and the control circuit is configured to operate the first DC/DC converter in a voltage-controlling mode with respect to the DC bus,
wherein the first AC/DC converter comprises a bidirectional AC/DC converter, and the control circuit is configured to operate the first AC/DC converter in a voltage-controlling mode with respect to the first AC terminal, and
one or more transformer units that are part of the one or more supply units, respectively, or via which the one or more supply units can be connected to an AC network, respectively.

16. The electrolysis system according to claim 15 wherein the one or more supply units comprise several supply units, wherein at least one of the one or more transformer units has more than two secondary windings, and wherein a plurality of supply units can be connected to the AC network via a common transformer unit.

17. The electrolysis system according to claim 15, additionally comprising an auxiliary energy source for charging the energy storage unit(s), wherein the auxiliary energy source is operated with hydrogen, and wherein the auxiliary energy source comprises an internal combustion engine or a fuel cell.
